(19) United States
(12) Patent Application Publication
(10) Pub. No.: US 2010/0197321 A1
(43) Pub. Date: Aug. 5, 2010

(54) APPARATUS AND METHOD FOR DETERMINING POSITION

(76) Inventors: Byung Doo Kim, Daejeon (KR); Wan Sik Choi, Daejeon (KR); Jong-Hyun Park, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/669,817

(22) PCT Filed: Jun. 24, 2008
(86) PCT No.: PCT/KR08/03594

§ 371 Date: Jan. 20, 2010

(30) Foreign Application Priority Data
Aug. 21, 2007 (KR) 10-2007-0083957

(51) Int. Cl. H04W 24/00

(52) U.S. Cl. 455/456.1

(57) ABSTRACT

A position determination device calculates a first estimate of positioning information of a terminal based on a non-dynamic model from a measurement value for calculating the positioning information of the terminal. The position determination device calculates a plurality of second estimates of the positioning information of the terminal from the first estimate based on each dynamic model. The position determination device combines the first estimate and the second estimates, and calculates the positioning information of the terminal from the combined value.

### BACKGROUND OF THE INVENTION

(a) Field of the Invention

The present invention relates to a position determination device and method thereof.

This work was supported by the IT R&D program of MIC/IITA [2007-F-040-01, Development of Indoor/Outdoor Seamless Positioning Technology].

(b) Description of the Related Art

Position determination technology is a skill for measuring the position of a terminal in a location determination system such as the global positioning system (GPS) or a wireless communication system such as the code division multiple access (CDMA), wireless local area network (WLAN), ultra wideband (UWB), and Bluetooth, and its application fields have been extended together with the increased recent demands for location information.

In general, a kinematic motion of a terminal can be divided as a section for moving at a constant speed and another section for moving at an accelerated speed. When the same kinematic model is set in the sections, a mismatch is generated between the motion of the model and the motion of the terminal. Therefore, the position determination technology for detecting the location of the terminal requires a tracking method using a kinematic model that is matched with the motion of the terminal according to the motion of the terminal.

Recently, a method using an interacting multiple model filter has been researched as a model configuring method satisfying these demands. The interacting multiple model filter configures Kalman filters having a plurality of different dynamic models in parallel, mixes an output of a filter of a previous cycle to use it as a filter input of a next cycle, and acquires an estimate of positioning information according to the weighted sum of estimates of the respective filters. However, when the kinematic characteristic of the terminal does not match the dynamic model of a plurality of Kalman filters, the interacting multiple model filter generates a mismatch between the motion of the dynamic model and the actual motion of the terminal to thus steeply deteriorate estimation performance on the positioning information.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a position determination device and method having advantages of improving estimation performance on positioning information of a terminal.

An exemplary embodiment of the present invention provides a position determination device for calculating positioning information of a terminal.

The position determination device includes a measurement value generator and a positioning information calculator

The measurement value generator generates a measurement value for calculating positioning information of the terminal from a radio signal received by the terminal. The positioning information calculator includes a first estimator and a plurality of second estimators, and calculates positioning information of the terminal from a first estimate of the first estimator and a plurality of second estimates of the second estimators. The first estimator calculates the first estimate of the positioning information from the measurement value based on a non-dynamic model, and the plurality of second estimators respectively calculate the plurality of second estimates of the positioning information from the first estimate based on respective dynamic models.

Another embodiment of the present invention provides a position determination method in a communication system including calculating a first estimate of positioning information of the terminal based on a non-dynamic model from a measurement value for calculating the positioning information, calculating a plurality of second estimates of the positioning information based on respective dynamic models from the first estimate, combining the first estimate and the plurality of second estimates, and calculating the positioning information from the combined value.

Yet another embodiment of the present invention provides a position determination device for calculating positioning information of a terminal. The position determination device includes a first estimator, a plurality of second estimators, a model probability updater, and a combiner. The first estimator calculates a first estimate of positioning information of the terminal based on a non-dynamic model from a measurement value for calculating the positioning information. The second estimators calculate a second estimate of the positioning information from the first estimate based on a dynamic model. The model probability updater calculates model probabilities of the first estimator and the plurality of second estimators for indicating conformity of the non-dynamic model and the dynamic model from the first estimate and the plurality of second estimates. The combiner allocates a weight to the first estimate and the plurality of second estimates according to the model probabilities of the first estimator and the plurality of second estimators, and calculates positioning information of the terminal from the summation of the weight allocated first estimate and second estimates.

According to the exemplary embodiment of the present invention, improved positioning information can be provided when the terminal generates a motion other than a predetermined model since estimates of a plurality of estimators based on a dynamic model are calculated from an estimate of an estimator based on a non-dynamic model.

### BRIEF DESCRIPTION OF THE DRAWINGS

FIG. 1 shows a block diagram of a position determination device according to a first exemplary embodiment of the present invention.

FIG. 2 shows a block diagram of a navigation information calculator shown in FIG. 1.

FIG. 3 shows a flowchart of an operational process of a navigation information calculator according to an exemplary embodiment of the present invention.

FIG. 4 and FIG. 5 show a position estimation error of a position determination device according to an exemplary embodiment of the present invention.

FIG. 6 and FIG. 7 show a speed estimation error of a position determination device according to an exemplary embodiment of the present invention.

FIG. 8 shows a block diagram of a position determination device according to a second exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and claims, unless explicitly described to the contrary, the word “comprise”, and variations such as “comprises” or “comprising”, will be understood to imply the inclusion of stated elements but not the exclusion of any other elements. Also, the terms of a unit, a device, and a module in the present specification represent a unit for processing a predetermined function or operation, which can be realized by hardware, software, or a combination of hardware and software.

In the specification, a terminal may indicate a portable subscriber station (PSS), a mobile terminal (MT), a subscriber station (SS), a mobile station (MS), user equipment (UE), or an access terminal (AT), and may include whole or partial functions of the mobile terminal, subscriber station, portable subscriber station, and user equipment. In the specification, a base station (BS) may indicate an access point (AP), a radio access station (RAS), a node B (Node B), or a base transceiver station (BTS), and may include whole or partial functions of the base station, the access point, the radio access station, the node B, and the base transceiver station.

A position determination device and method according to an exemplary embodiment of the present invention will now be described with reference to the accompanying drawings.

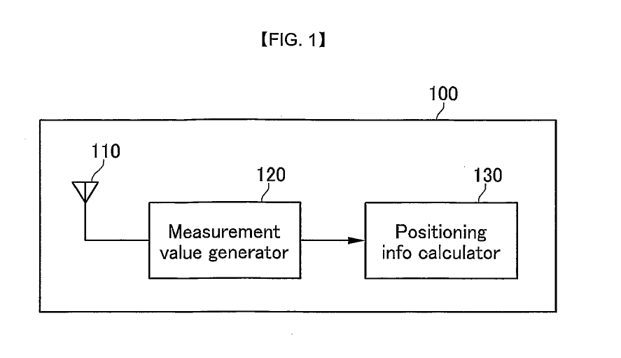

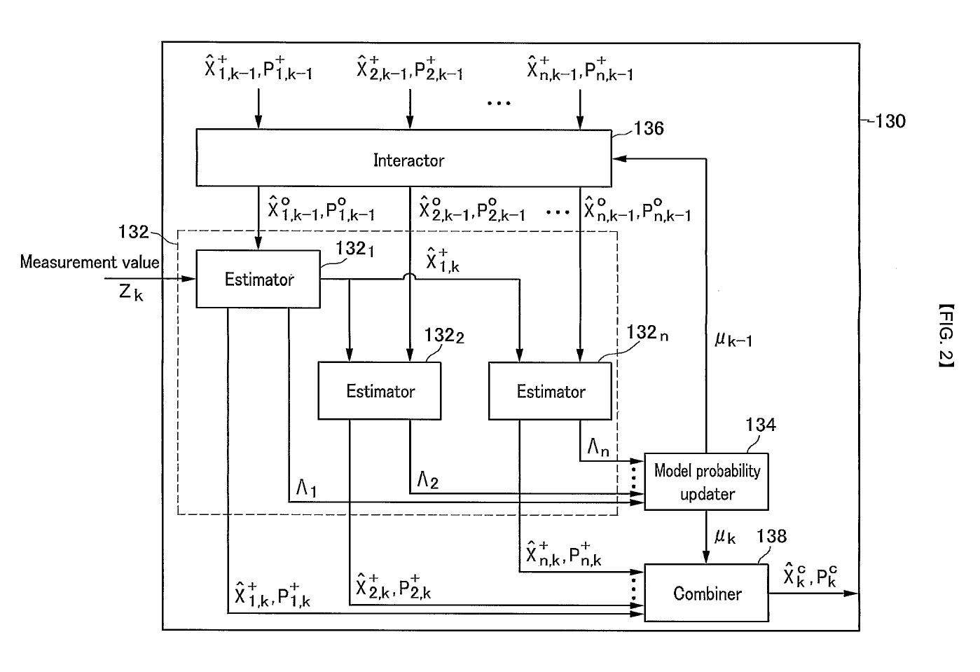

FIG. 1 shows a brief block diagram of a position determination device according to a first exemplary embodiment of the present invention, and FIG. 2 shows a block diagram of a positioning information calculator shown in FIG. 1.

As shown in FIG. 1, the position determination device 100 includes an antenna 110, a measurement value generator 120, and a positioning information calculator 130.

The antenna 110 receives radio signals from one of a satellite navigation system such as a GPS, a base station of a wireless communication system, a repeater, and a GPS satellite.

The measurement value generator 120 generates measurement values required for calculating positioning information from the radio signals received by the position determination device 100, that is, the terminal, through the antenna 110. The measurement values include a propagation delay time, signal strength, and distanbe, and the positioning information includes location and/or speed.

The navigation information calculator 130 calculates positioning information from the generated measurement values.

As shown in FIG. 2, the positioning information calculator 130 includes a multiple model estimator 132, a model probability updater 134, an interactor 136, and a combiner 138.

The multiple model estimator 132 includes a plurality of estimators (132₁-132ₙ). In this instance, the estimator 132₁ calculates an estimate of positioning information from the measurement value generated by the measurement value generator 120 based on the non-dynamic model. The other estimators (132₂-132ₙ) from among the plurality of estimators (132₁-132ₙ) calculates estimates of the positioning information based on the estimates calculated by the estimator 132₁ based on the dynamic model. The estimator 132₁ can be configured by a least square estimator or a weighted least square estimator, and the estimators (132₂-132ₙ) can be configured by Kalman filters coupled in parallel. In this instance, the estimators (132₂-132ₙ) can be configured based on the same dynamic model, or based on different dynamic kinematic models. In the following, positioning information to be estimated by using the estimators (132₁-132ₙ) will be defined as “state variable”, and estimated positioning information will be defined as “state estimate”.

First, when the estimator 132₁ is configured by the least square estimator, a measurement equation between the measurement value and the state variable at the time of k is expressed in Equation 1.

zₖ=H_{1,k}x_{1,k}+w_{1,k} Equation 1

Here, zₖ is a measurement value generated by the measurement value generator 120, H_{1,k} is an observation matrix of the estimator 132₁, and w_{1,k} is a measurement noise vector of the estimator 132₁ for the measurement equation.

The estimator 132₁ calculates a state estimate (\hat{x}_{1,k}⁺), which is the solution of Equation 1, and a state error covariance (P_{1,k}⁺) indicating an error range of the state estimate (\hat{x}_{1,k}⁺). In this instance, the state estimate (\hat{x}_{1,k}⁺) and the state error covariance (P_{1,k}⁺) are calculated by Equation 2 and Equation 3.

\hat{x}_{1,k}⁺=(H_{1,k}^{T}H_{1,k})⁻¹H_{1,k}^{T}zₖ Equation 2

P_{1,k}⁺=(H_{1,k}^{T}R⁻¹H_{1,k})⁻¹ Equation 3

In Equation 3, R is a measurement error covariance matrix, and T is a transpose of the observation matrix.

The estimator 132₁ calculates a likelihood ratio by using the measurement error covariance matrix (R) and measurement residuals (\tilde{z}_{1,k}). In this instance, the measurement residuals (\tilde{z}_{1,k}) are calculated as expressed in Equation 4 when the measurement equation is a linear equation, and the same can be calculated as expressed in Equation 5 when the measurement equation is a non-linear equation.

\tilde{x}_{1,k}=zₖ−\hat{z}_{1,k}=zₖ−H_{1,k}\hat{x}_{1,k} Equation 4

\tilde{z}_{1,k}=zₖ−\hat{z}_{1,k}=zₖ−f(\hat{x}_{1,k}) Equation 5

In general, the measurement equation is given as a non-linear equation, and the likelihood ratio (Λ_{1,k}) can be calculated as expressed in Equation 6.

$${Λ}_{1 , k} = \frac{1}{\sqrt{2 π \vert R \vert}} exp ( - \frac{1}{2} {\tilde{z}}_{1 , k}^{T} {R}^{- 1} {\tilde{z}}_{1 , k} ) \qquad Equation 6$$

Next, when a plurality of estimators (132₂-132ₙ) are configured by Kalman filters that respectively have a dynamic model and are configured in parallel, the state equation and the measurement equation at the time k are expressed as Equation 7 and Equation 8.

x_{i,k}=Fᵢx_{i,k-1}+Qᵢ Equation 7

In Equation 7, i=2˜n, Fᵢ is a state transition matrix for the dynamic model of the i-th estimator 132ᵢ, Qᵢ is a fair error covariance matrix for the dynamic model of the i-th estimator 132ᵢ, and x_{i,k-1} is an output value (\hat{x}_{i,k-1}^{o}, P_{i,k-1}^{o}) of the interactor 136 at the time (k−1).

zₖ=H_{i,k}x_{i,k}+wₖ Equation 8

In Equation 8, zₖ is a state estimate (\hat{x}_{1,k}⁺) of the estimator 132₁, H_{i,k} is an observation matrix of the i-th estimator 132ᵢ for the dynamic model, and wₖ is a measurement noise vector.

Referring to Equation 7 and Equation 8, the respective estimators (132₂-132ₙ) calculate the state estimate and the state error covariance. The state estimate (\hat{x}_{i,k}⁺) and the state error covariance (P_{i,k}⁺) of the i-th estimator 132ᵢ are calculated by Equation 12. In this instance, Equation 9 and Equation 10 are prediction equations of the state estimate (\hat{x}_{i,k}⁻) and the state error covariance (P_{i,k}⁻) and Equation 11 and Equation 12 are update equations of the state estimate (\hat{x}_{i,k}⁺) and the state error covariance (P_{i,k}⁺). In Equation 11, the former is an update equation when the measurement equation is a linear equation, and the latter is an update equation when the measurement equation is a non-linear equation. The updated values by Equation 11 and Equation 12 are the state estimate (\hat{x}_{i,k}⁺) and the state error covariance (P_{i,k}⁺), which are output values of the estimator 132ᵢ.

\hat{x}_{i,k}⁻=Fᵢ\hat{x}_{i,k-1}⁺ Equation 9

P_{i,k}⁻=FᵢP_{i,k-1}⁺Fᵢ^{T}+Qᵢ Equation 10

\hat{X}_{i,k}⁺=\hat{x}_{i,k}⁻+K_{i,k}(zₖ−H_{i,k}\hat{x}_{i,k}⁻) or \hat{x}_{i,k}⁺=\hat{x}_{i,k}⁻+K_{i,k}(z−f(\hat{x}_{i,k}⁻)) Equation 11

P_{i,k}⁺=(Iᵢ−K_{i,k}H_{i,k})P_{i,k}⁻ Equation 12

In Equation 11 and Equation 12, it is given that K_{i,k}=P_{i,k}H_{i,k}^{T}S_{i,k}⁻¹ and S_{i,k}=H_{i,k}P_{i,k}⁻H_{i,k}^{T}+R_{i,k}. In this instance, K_{i,k} is a Kalman gain matrix, S_{i,k} is a covariance for the error of the measurement residual, and R_{i,k} is a state error covariance (P_{1,k}) for the estimator 132₁.

The respective estimators (132₂-132ₙ) calculate the likelihood ratio from the predicted values of Equation 9 and Equation 10. The likelihood ratio of the i-th estimator 132ᵢ is calculated as Equation 13.

$${Λ}_{i , k} = \frac{1}{\sqrt{2 π \vert {S}_{i , k} \vert}} exp ( - \frac{1}{2} {\tilde{z}}_{i , k}^{T} {S}_{i , k}^{- 1} {\tilde{z}}_{i , k} ) \qquad Equation 13$$

In Equation 13, z_{i,k} is a measurement residual, and S_{i,k} is a covariance for the measurement residual. In this instance, the measurement residual (\tilde{z}_{i,k}) is calculated as expressed in Equation 14.

\tilde{z}_{i,k}=zₖ−\hat{z}_{i,k} Equation 14

In Equation 14, it is given that \hat{z}_{i,k}=H_{i,k}\hat{x}_{i,k}⁻ when the measurement equation is a linear equation, and it is given that \hat{z}_{i,k}=f(\hat{x}_{i,k}⁻) when the measurement equation is a non-linear equation.

The model probability updater 134 updates the model probability of the estimators (132₁-132ₙ) by using the likelihood ratio calculated by the estimator (132₁-132ₙ). The model probability of the estimators (132₁-132ₙ) assigns a weight to the outputs of the estimators (132₁-132ₙ), and shows the conformity of the model. The model probability (μ_{j,k}) of the j-th estimator 132ⱼ is calculated as expressed in Equation 15.

$${μ}_{j , k} = \frac{1}{c} {Λ}_{j , k} {\overline{c}}_{j} \qquad Equation 15$$

In Equation 15, j=1˜n, c is a normalization constant, and

$$c = {\sum }_{i = 1}^{n} {Λ}_{i , k} {\overline{c}}_{i} .$$

The interactor 136 interacts the model probability of the estimators (132₁-132ₙ) at the previous time, that is the time (k−1) with the state estimates (\hat{x}_{1,k-1}⁺, . . . , \hat{x}_{n,k-1}⁺) and the state error covariance (P_{1,k-1}⁺, . . . , P_{n,k-1}⁺) to output results to the estimators (132₁-132ₙ) at the time k. That is, the output value of the interactor 136 at the previous time is set to be an initial value of the estimators (132₁-132ₙ).

In detail, the interactor 136 calculates a mixture probability of the estimators (132₁-132ₙ) at the time k by using the model probability (μₖ₋₁) of the estimators (132₁-132ₙ) at the time k−1. In this instance, the mixture probability represents the probability (μ_{i|j,k}) of transiting from the j-th dynamic model to the i-th dynamic model at the time k, and it can be calculated as Equation 16.

$${μ}_{i \vert j , k} = \frac{1}{{\overline{c}}_{j}} {p}_{ij} {μ}_{i , k - 1} \qquad Equation 16$$

In Equation 16, c̅ⱼ is a normalizing constant, μ_{i,k-1} is a probability of the i-th model of the i-th estimator 132; at the time (k−1) and is the i-th component of μₖ₋₁. Pᵢⱼ is a model transition probability, it is the ij-th component of the transition matrix between the dynamic models, and it is defined as an n×n matrix.

The interactor 136 calculates the mixture estimate (\hat{x}_{j,k}^{o}) and mixture error covariance (P_{j,k}^{o}) for each dynamic model at the time k and outputs results to the corresponding estimators (132₁-132ₙ). The mixture state estimate (\hat{x}_{j,k}^{o}) and the mixture state error covariance (P_{j,k}^{o}) are calculated as expressed in Equation 17 and Equation 18.

$$\begin{matrix}{\hat{x}}_{j , k}^{o} = {\sum }_{i = 1}^{n} {\hat{x}}_{i , k - 1}^{+} {μ}_{i \vert j , k} & Equation 17 \\ {P}_{j , k}^{o} = {\sum }_{i = 1}^{n} \{ {P}_{i , k - 1}^{+} + {A}_{j} {A}_{j}^{T} \} {μ}_{i \vert j , k} & Equation 18\end{matrix}$$

In Equation 18, it is given that Aⱼ=\hat{x}_{i,k-1}⁺−\hat{x}_{j,k}^{o}.

The combiner 138 outputs a combined state estimate (\hat{x}ₖ^{c}) and combined state error covariance (Pₖ^{c}) by combining the state estimates (\hat{x}_{1,k}⁺, . . . , \hat{x}_{n,k}⁺) and state error covariance (P_{1,k}⁺, . . . , P_{n,k}⁺) calculated by the estimators (132₁-132ₙ) according to the model probability (P_{1,k}⁺, . . . , P_{n,k}⁺) of the estimators (132₁-132ₙ). The combined state estimate (\hat{x}ₖ^{c}) and the combined state error covariance (Pₖ^{c}) are calculated as expressed in Equation 19 and Equation 20. In this instance, the combined state estimate (\hat{x}ₖ^{c}) and the combined state error covariance (Pₖ^{c}) that are output values of the combiner 138 become positioning information to be calculated by the positioning information calculator 130.

$$\begin{matrix}{\hat{x}}_{k}^{c} = {\sum }_{j = 1}^{n} {\hat{x}}_{j , k}^{+} {μ}_{j , k} & Equation 19 \\ {P}_{k}^{c} = {\sum }_{j = 1}^{n} \{ {P}_{j , k}^{+} + {B}_{j} {B}_{j}^{T} \} {μ}_{j , k} & Equation 20\end{matrix}$$

In Equation 20, it is given that Bⱼ=\hat{x}_{j,k}⁺−\hat{x}ₖ^{c}.

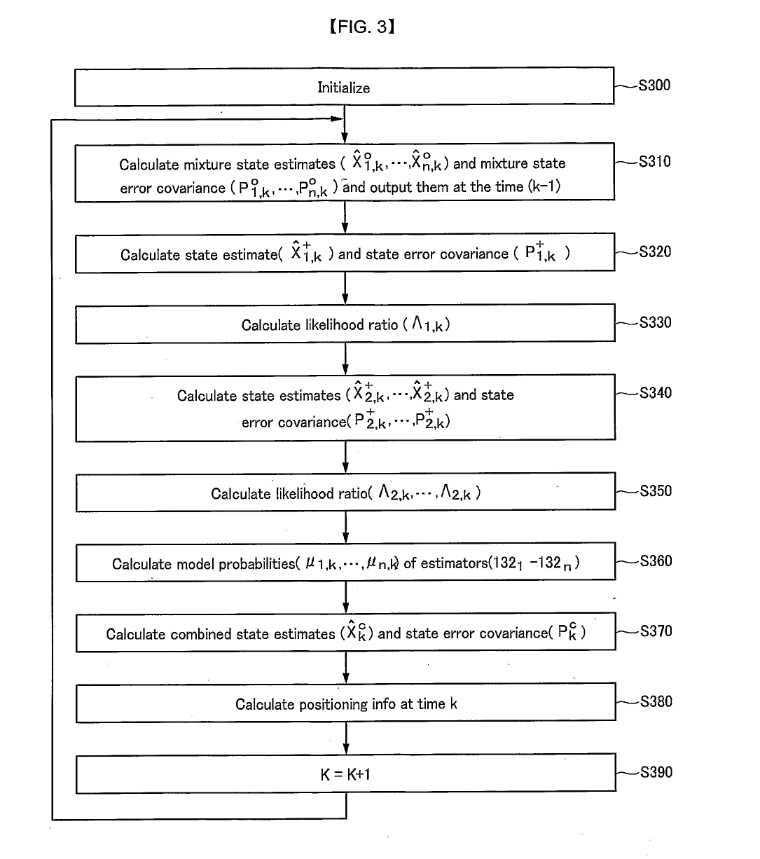

A method for a positioning information calculator according to an exemplary embodiment of the present invention to calculate positioning, information will be described in detail with reference to FIG. 3.

FIG. 3 shows a flowchart of a positioning information calculator according to an exemplary embodiment of the present invention.

As shown in FIG. 3, in order to calculate positioning information of the terminal at the time k, the positioning information calculator 130 initializes the variables of the measurement equation (S300).

The interactor 136 calculates mixture state estimates (\hat{x}_{1,k-1}^{o}, . . . , \hat{x}_{n,k-1}^{o}) and mixture state error covariance (P_{1,k-1}^{o}, . . . , P_{n,k-1}^{o}) at the time (k−1) and outputs results (S310). Here, the interactor 136 interacts the model probability (μ_{1,k-1}, . . . , μ_{n,k-1}) of the estimators (132₁-132ₙ) with the state estimates (\hat{x}_{1,k-1, . . . , \hat{x}}_{n,k-1}⁺) and state error covariance (P_{1,k-1}⁺P_{1,k-1}⁺, . . . , P_{n,k-1}⁺), which are output values of the estimators (132₁-132ₙ), and outputs interacted mixture state estimate (\hat{x}_{1,k-1}, . . . , \hat{x}_{n,k-1}^{o}) and mixture state error covariance (P_{1,k-1}, . . . , P_{n,k-1}^{o}) to the estimators (132₁-132ₙ) at the time (k+1). When it is given that k=1, the interactor 136 outputs 0 as the mixture state estimate (\hat{x}_{i,0}^{o}) and the mixture state error covariance (P_{i,0}^{o}).

The estimator 132₁ calculates the state estimate (\hat{x}_{1,k}⁺) and the state error covariance (P_{1,k}⁺) and outputs them to the estimators (132₂-132ₙ) and the combiner 138 by using the measurement value (zₖ), the mixture state estimate (\hat{x}_{1,k-1}^{o}) and the mixture state error covariance (P_{1,k-1}^{o}) (S320), and calculates the likelihood ratio (Λ_{1,k}) and outputs it to the model probability updater 134 by using the measurement error covariance (R) and the measurement residual (\tilde{z}1,k) (S330). The estimator 132₁ calculates the state estimate (\hat{x}_{1,k}⁺) and the state error covariance (P_{1,k}⁺) without using the mixture state estimate (\hat{x}_{1,k-1}^{o}) and the mixture state error covariance (P_{1,k-1}^{o}) as shown in Equation 2 and Equation 3, and it can also calculate the state estimate (\hat{x}_{1,k}⁺) and the state error covariance (P_{1,k}⁺) by using the mixture state estimate (\hat{x}_{1,k-1}^{o}) and the mixture state error covariance (P_{1,k-1}^{o}).

The estimator (132₂-132ₙ) calculates state estimates (\hat{x}_{2,k}⁺, . . . , \hat{x}_{n,k}⁺) and state error covariance (P_{2,k}⁺, . . . , P_{n,k}⁺) from the state estimate (\hat{x}_{1,k}⁺) that is an output value from the estimator 132₁ and the mixture state estimates (\hat{x}_{2,k-1}, . . . , \hat{x}_{n,k-1}^{o}) and the mixture state error covariance (P_{2,k-1, . . . , P}_{n,k-1}^{o}) that are output values of the interactor 136 at the previous time (k−1), and outputs the calculated result to the combiner 138 (S340).

Also, the estimators (132₂-132ₙ) uses the state prediction values (\hat{x}_{2,k}⁻, . . . , \hat{x}_{n,k}⁻) and measurement residuals (\tilde{z}_{2,k}, . . . , \tilde{z}_{n,k}) to calculate the likelihood ratios (Λ_{2,k}, . . . , Λ_{n,k}) and outputs them to the model probability updater 134 (S350).

The model probability updater 134 uses the likelihood ratios (Λ_{1,k}, . . . , Λ_{n,k}) calculated by the estimators (132₁-132ₙ) to calculate the model probability (μ_{1,k}, . . . , μ_{n,k}) of the estimators (132₁-132ₙ) and outputs the same to the interactor 136 and the combiner 138 (S360).

The combiner 138 uses the model probability (μ_{1,k}, . . . , μ_{n,k}), state estimate (\hat{x}_{1,k}⁺, . . . , \hat{x}_{n,k}⁺), and state error covariance (P_{1,k}⁺, . . . , P_{n,k}⁺) of the estimators (132₁-132ₙ) to calculate the combined state estimate (\hat{x}ₖ^{c}) and combined state error covariance (Pₖ^{c}) and outputs them (S370). Positioning information at the time k is calculated from the calculated combined state estimate (\hat{x}ₖ^{c}) and combined state error covariance (Pₖ^{c}) (S380).

After this, 1 is added to k and the steps (S310-S380) are repeated to determine positioning information at the respective times (S390).

According to the exemplary embodiment of the present invention, even when the terminal performs motions other than the dynamic model that is established in the estimators (132₂-132ₙ), the estimators (132₂-132ₙ) calculates the state estimate (\hat{x}_{j,k}⁺) based on the state estimate (\hat{x}_{1,k}⁺) of the estimator 132₁ following the non-dynamic model so that the error of the positioning calculation can be reduced compared to the case in which the multiple model estimator 132 is configured by the estimator based on the dynamic model such as the Kalman filter.

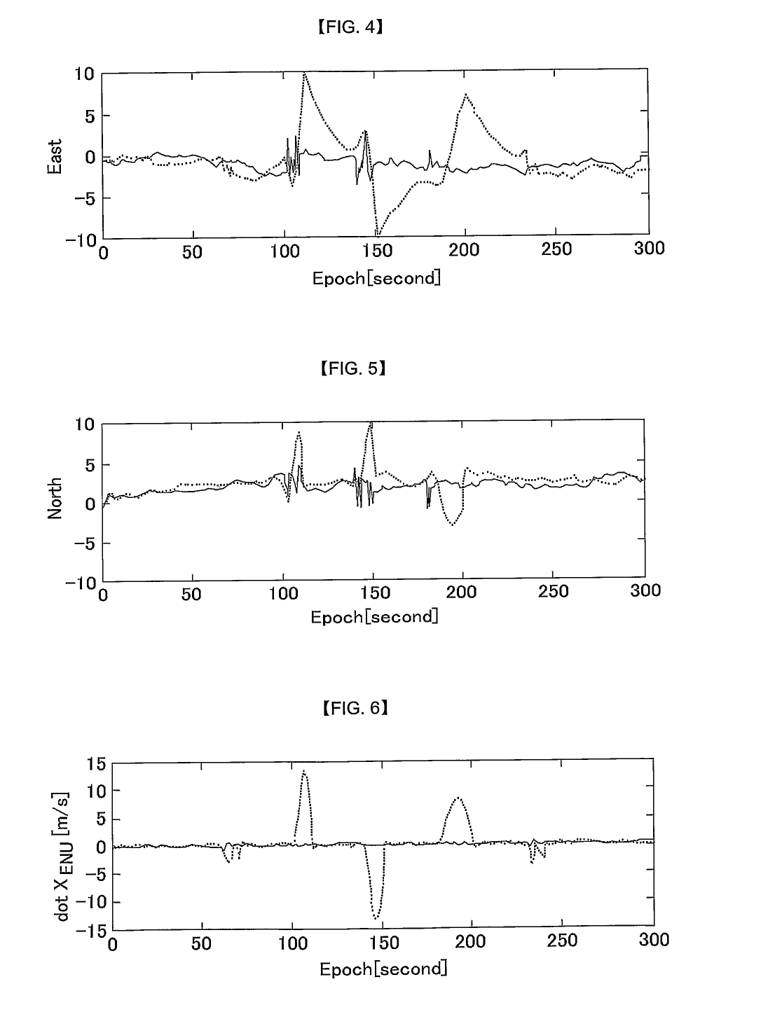

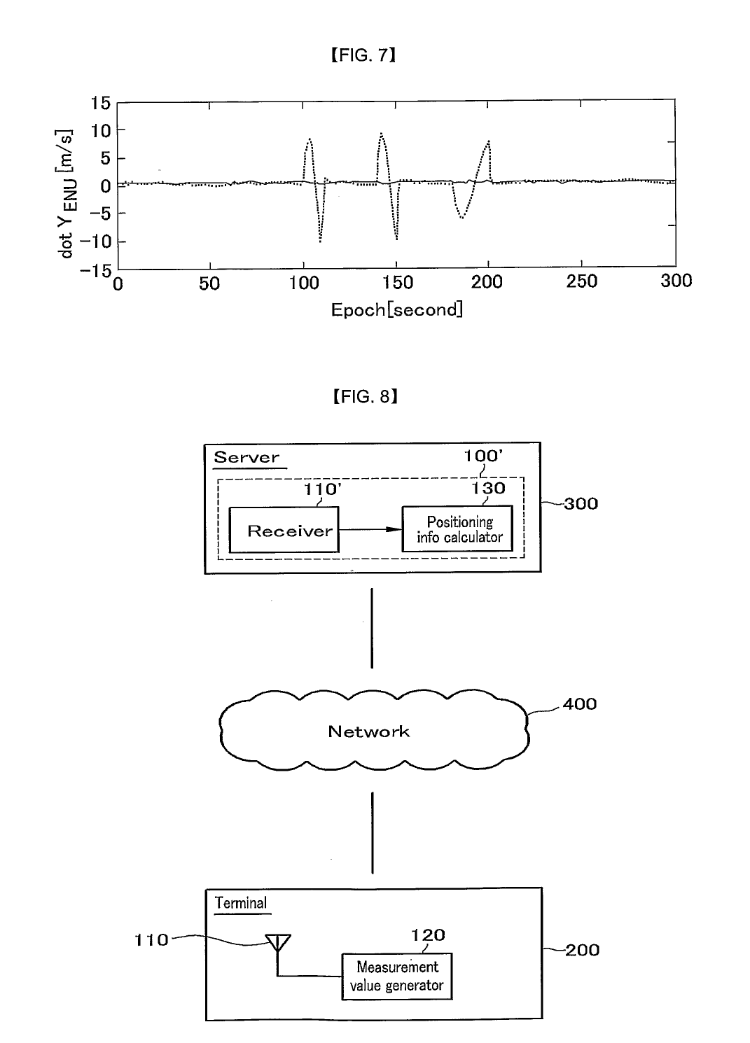

Next, estimation performance for the case of including an estimator based on the non-dynamic model in the multiple model estimator 132 and estimation performance for the case of not including an estimator based on the non-dynamic model in the multiple model estimator 132 will be described with reference to FIG. 4, FIG. 5, FIG. 6 and FIG. 7.

FIG. 4 and FIG. 5 show location estimation errors of a position determination device according to an exemplary embodiment of the present invention, and FIG. 6 and FIG. 7 show speed estimation errors of a position determination device according to an exemplary embodiment of the present invention. Referring to FIG. 4, FIG. 5, FIG. 6, and FIG. 7, the solid lines indicate the case in which an estimator based on the non-dynamic model is included in the multiple model estimator 132 according to the exemplary embodiment of the present invention, and the dotted lines indicate the other case. In detail, FIG. 4 shows the location estimation error for the eastern direction of the position determination device 100 in the east-north-up (ENU) coordinate system, and FIG. 5 shows the location estimation error for the northern direction of the position determination device 100 in the east-north-up (ENU) coordinate system. Also, FIG. 6 indicates the speed estimation error for the eastern direction of the position determination device 100 in the east-north-up (ENU) coordinate system, and FIG. 7 indicates the speed estimation error for the northern direction of the position determination device 100 in the east-north-up (ENU) coordinate system.

As can be known from FIG. 4, FIG. 5, FIG. 6, and FIG. 7, the position determination device 100 according to the exemplary embodiment of the present invention generates less location and speed estimation errors compared to the case in which the multiple model estimator 132 includes the estimator based on the dynamic model.

FIG. 8 shows a position determination device according to a second exemplary embodiment of the present invention.

As shown in FIG. 8, the position determination device 100′ according to the second exemplary embodiment of the present invention can be located in a server 300 for providing a service to the terminal 200 through the network 400. The position determination device 100′ includes a receiver 110′ and a positioning information calculator 130. The receiver 110′ receives measurement values required for calculating positioning information from the terminal 200. The positioning information calculator 130 calculates positioning information from the received measurement values. Constituent elements of the positioning information calculator 130 and the method for calculating positioning information by the positioning information calculator 130 correspond to those of the first exemplary embodiment.

The terminal 200 includes an antenna 110 and a measurement value generator 120 so as to transmit the measurement value to the position determination device 100′ through the network 400.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A position determination device for calculating positioning information of a terminal comprising:
a measurement value generator for generating a measurement value for calculating positioning information of the terminal from a radio signal received by the terminal; and
a positioning information calculator including a first estimator and a plurality of second estimators and calculating positioning information of the terminal from a first estimate of the first estimator and a plurality of second estimates of the second estimators, wherein
the first estimator calculates the first estimate of the positioning information from the measurement value based on a non-dynamic model, and
the plurality of second estimators respectively calculate the plurality of second estimates of the positioning information from the first estimate based on respective dynamic models.

2. The position determination device of claim 1, wherein
the positioning information calculator further includes:
a model probability updater for calculating model probabilities of the first estimator and the plurality of second estimators for indicating conformity of the non-dynamic model and the dynamic model based on the first estimate and the second estimates; and
a combiner for allocating a weight to the first estimate and the second estimates according to the model probabilities of the first estimator and the second estimators, combining them, and calculating the positioning information from the combined values.

3. The position determination device of claim 2, wherein
the first estimator and the plurality of second estimators respectively calculate a likelihood ratio from error covariance of the first estimate and the plurality of second estimates, and
the model probability updater calculates the model probability from the likelihood ratio.

4. The position determination device of claim 3, wherein
the plurality of second estimators calculate error covariance of the plurality of respective second estimates from the error covariance of the first estimate.

5. The position determination device of claim 3, wherein the device further includes:
an interactor for setting initial values of the plurality of second estimators at the time k from the plurality of second estimates at the time (k−1) and the model probabilities of the second estimators at the time (k−1), wherein
the plurality of second estimators calculate the plurality of second estimates at the time k from the initial value at the time k and the first estimate at the time k.

6. The position determination device of claim 1, wherein the first estimator calculates the first estimate by using the least square method or the weighted least square method.

7. The position determination device of claim 1, wherein the plurality of second estimators are configured by Kalman filters having different dynamic models.

8. A position determination method in a communication system comprising:
calculating a first estimate of positioning information of the terminal based on a non-dynamic model from a measurement value for calculating the positioning information;
calculating a plurality of second estimates of the positioning information based on respective dynamic models from the first estimate;
combining the first estimate and the plurality of second estimates; and
calculating the positioning information from the combined value.

9. The position determination method of claim 8, wherein
calculating error covariance of the first estimate and the plurality of second estimates from the first estimate and the plurality of second estimates;
calculating a likelihood ratio from error covariance of the first estimate and the plurality of second estimates; and
calculating model probabilities for indicating conformity of the non-dynamic model and the dynamic models from the likelihood ratio, and
the combined value is generated by multiplying the model probabilities corresponding to the first estimate and the plurality of second estimates and summing the multiplied results.

10. The position determination method of claim 9, further including
calculating an initial value at the time k from the calculated model probability at the time (k−1) and the plurality of second estimates at the time (k−1), and
a plurality of second estimates at the time k are found from a first estimate at the time k and an initial value at the time k−1.

11. The position determination method of claim 9, wherein
error covariance of the plurality of second estimates is calculated from error covariance of the first estimate.

12. The position determination method of claim 8, further including
generating the measurement value from the radio signal received by the terminal.

13. A position determination device for calculating positioning information of a terminal comprising:
a first estimator for calculating a first estimate of positioning information of the terminal based on a non-dynamic model from a measurement value for calculating the positioning information;
a plurality of second estimators for calculating a second estimate of the positioning information from the first estimate based on a dynamic model;
a model probability updater for calculating model probabilities of the first estimator and the plurality of second estimators for indicating conformity of the non-dynamic model and the dynamic model from the first estimate and the plurality of second estimates; and
a combiner for allocating a weight to the first estimate and the plurality of second estimates according to the model probabilities of the first estimator and the plurality of second estimators, and calculating positioning information of the terminal from the summation of the weight allocated first estimate and second estimates.

14. The position determination device of claim 13, wherein the device further includes
an interactor for providing an initial value of the plurality of second estimators at the time k by using the model probabilities of the plurality of second estimators and the plurality of second estimates at the time (k−1), wherein
the plurality of second estimators calculates the plurality of second estimates at the time k from the initial value at the time k and the first estimate at the time k.

15. The position determination device of claim 13, further including a measurement value generator for generating the measurement value from the radio signal received by the position determination device.

16. The position determination device of claim 13, wherein the position determination device is located in a server for providing a service to the terminal through a network, and
the measurement value is generated from the radio signal received by the terminal.
